(19) United States
(12) Patent Application Publication
(10) Pub. No.: US 2021/0271193 A1
(43) Pub. Date: Sep. 2, 2021

(54) SELECTIVELY HEATABLE BELT FUSER

(71) Applicant: Toshiba TEC Kabushiki Kaisha, Shinagawa-ku (JP)

(72) Inventor: Paul J. MENZEL, Lexington, KY (US)

(21) Appl. No.: 16/804,601

(22) Filed: Feb. 28, 2020

(51) Int. Cl. G03G 15/20

(52) U.S. Cl. CPC G03G 15/2053

(57) ABSTRACT

A belt fuser. The belt fuser has a first roller arranged on the surface side of a recording medium conveyed in a conveyance path and a second roller arranged opposite to the first roller to sandwich and mutually pressurize the conveyance path. An interior heater is suitably disposed interiorly to the first roller, the interior heater providing a first heat source to an exterior surface of the first roller. An exterior heater is suitably disposed exteriorly to the first roller, the exterior heater providing a second heat source to selectively heat select portions of the exterior surface of the first roller.

### TECHNICAL FIELD

This application relates generally to belt fusers in document processing devices. The application relates more particularly to a belt fuser for facilitating more efficient fixing of a toner image on a sheet conveyed in a document processing device, such as a copier.

### BACKGROUND

Document processing devices, including printers, copiers, scanners and multifunction peripherals (MFPs) or multifunction devices (MFDs), often utilize a belt fuser, or fixing device, that fixes a toner image transferred to a medium, such as paper, in a document processing device, such as a copier. Fixing is achieved by heating portions of the belt fuser.

### BRIEF DESCRIPTION OF THE DRAWINGS

Various embodiments will become better understood with regard to the following description, appended claims and accompanying drawings wherein:

FIG. 1 is an example embodiment of document processing device;

FIG. 2 is a schematic illustration of example components of a document processing device;

FIG. 3 is an example embodiment of a fuser used in a document processing device;

FIG. 4 is a schematic illustration of example of a selectively heatable belt fuser;

FIG. 5 is a perspective view of an example exterior heater; and

FIG. 6 is a schematic representation of print media in the form of a sheet of paper on a heating belt and having toner particles disposed thereon.

### DETAILED DESCRIPTION

The apparatuses, systems and methods disclosed herein are described in detail by way of examples and with reference to the figures. It will be appreciated that modifications to disclosed and described examples, arrangements, configurations, components, elements, apparatuses, devices methods, systems, etc. is suitably made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

The apparatuses, systems and methods disclosed herein relate to document processing devices including printers, copiers, scanners and multifunction peripherals (MFPs) or multifunction devices (MFDs) that utilize a sliding drawer, or cassette, that holds a supply of paper, such as a stack of paper. As used herein, MFPs are understood to comprise copiers or printers, alone or in combination with other of the afore-noted functions. It is further understood that any suitable document processing device is suitably used.

As noted above, the fuser in a document processing device utilizes heat to fix toner to a medium, such as paper, as a toner image. The heat is suitably provided by a heating device that delivers heat to a roller, or to the belt of a belt fuser. Because the entire belt of a belt fuser is heated for what is suitably a little as 1%-3% toner coverage of the paper to which toner is affixed, heating efficiency can be improved by improving the heating apparatus associated with the belt fuser. Beneficial apparatuses, systems, and methods of heating a belt fuser of a document processing device are disclosed herein. As used herein, the term “belt fuser” is intended to cover all such rollers, belts, and the like, as is known for fusing toner.

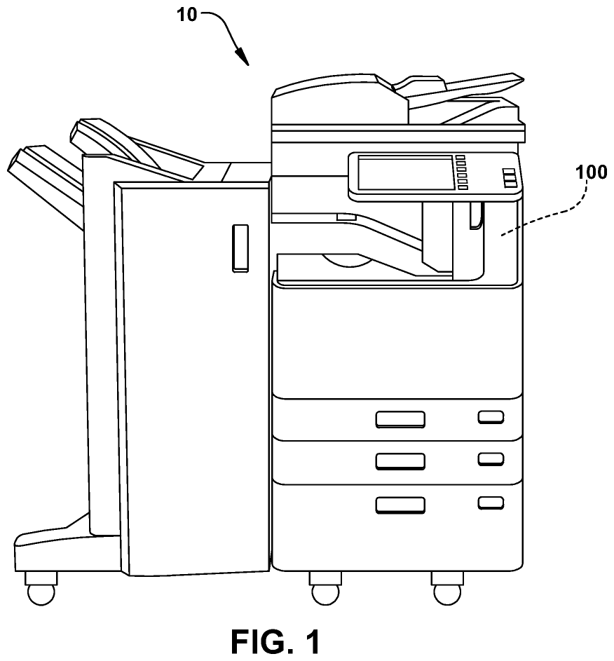

In accordance with the subject application, FIG. 1 illustrates an example embodiment of a document processing device 10 that includes a belt fuser 100 as an internal component. The document processing device 10 is suitably a printer, copier, scanner, multifunction peripheral (MFPs) or a multifunction device (MFDs). In general, any of known document processing device components is suitably used with the example apparatuses, systems, and methods disclosed herein.

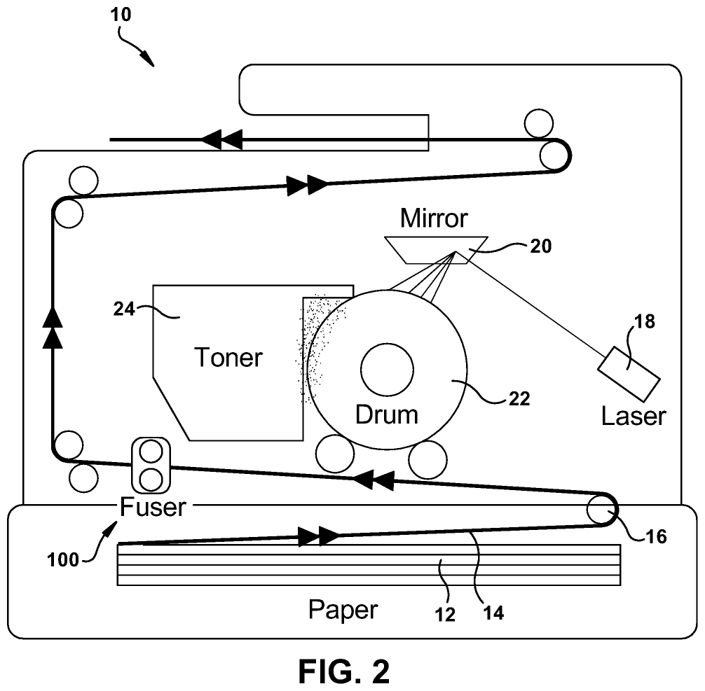

Turning now to FIG. 2, illustrated is a portion of a document processing device 10 illustrating the operational environment for an example belt fuser 100. Paper 12 from a paper stack is suitably drawn and conveyed in a paper path 14 over a series of rollers 16. A laser 18 transmits light across a series of mirrors 20 to reflect onto a drum 22 to imprint the shape of the intended image. Toner 24 suitably transfers toner particles onto the paper as a toner image, which is then passed through a belt fuser, which is suitably an example belt fuser 100, as disclosed herein, for facilitating efficient heating and melting of the toner particles onto the page as it passes through. This heating and melting seals the toner to the page so it's no longer in powder form and ensures that the toner doesn't smudge or fall off the paper when it comes out of the document processing device.

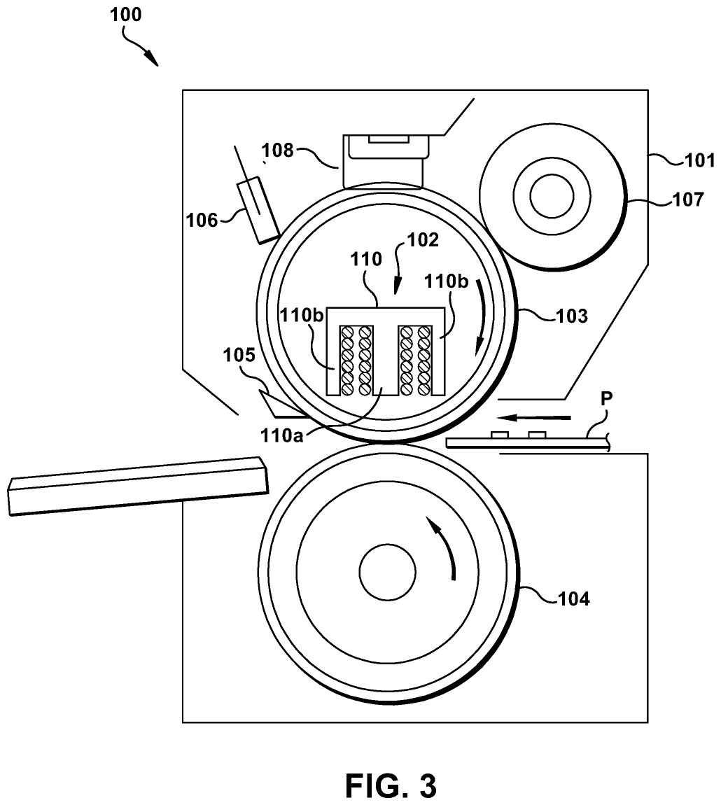

Turning now to FIG. 3, illustrated is a non-limiting example belt fuser 100. The belt fuser illustrated in FIG. 3 is intended to illustrate certain components, such as a representative interior heater. However, it is understood that other components, including other interior heaters, other materials, other configurations, and other features as is known in the art, is suitably used. A heating roller 103, which is suitably about 30 mm in diameter and suitably has a length sufficient to handle the desired width of print medium, such as paper, is suitably a heating belt, is suitably a first roller or a first contacting member containing an interior heater 102 in its inside, an is suitably disposed in a main body 101. The interior heater 102 is suitably a conduction heater. The heating roller 103 is suitably connected to a driving mechanism (not shown) and is rotated and driven in the arrow direction. The heating roller 103 is suitably a first roller arranged on the first side of a fixing medium P, such as a sheet of paper, the first side of the fixing medium P being the surface side on which toner T is applied.

A pressure roller, which is suitably about 30 mm in diameter and suitably has a length sufficient to handle the desired width of print medium, such as paper, is suitably urged against the heating roller 103 by a pressure mechanism (not shown) is suitably in contact with the heating roller 103 so as to have a fixed nip width under the pressed state. The pressure mechanism is suitably a spring-biased pressure mechanism. Accordingly, the pressure roller 104 rotates in the arrow direction shown in the figure following the heating roller 103.

The heating roller 103 is suitably made of iron in a thickness of about 0.6 mm. The surface of the heating roller 103 is suitably covered by a mold lubricant layer such as TEFLON®. The pressure roller 104 is suitably include a pliable covering around the core metal, such as silicon rubber, fluoro rubber, and the like.

When the fixing medium P, for example, paper, passes through a fixing point that is the nip portion between the heating roller 103 and the pressure roller 104, a developer, such as toner, on the fixing medium P is fixed through the fusion and press fit.

On the outer surface of the heating roller 103, a separation claw 105 is suitably provided at the downstream side in the rotating direction from the nip portion between the heating roller 103 and the pressure roller 104 to separate a fixing medium P from the heating roller 103. In addition, on the outer surface of the heating roller 103, there is suitably provided a cleaner 106 to remove offset-toner, dust like waste paper, and the like on the heating roller 103, a mold lubricant coating unit 107 to coat an offset preventive mold lubricant, and a thermistor 108 to detect a temperature of the heating roller 103.

By way of example, one embodiment of an interior heater 102 suitable for use in the belt fuser 100 is suitably made of a ferrite that is a high permeable material and is equipped with a core 110 formed in E-shaped section with the open end facing downward and a coil 111. The coil 111 is suitably made as a Litz Wire using a copper wire in 0.5 mm diameter and wound round the core 110 by plural turns along its longitudinal direction. The longitudinal direction of the core 110 is suitably opposite to nearly the overall length in the axial direction of the heating roller 103. As the open end of this core faces downward, the core has three opposing points; a center projection 110a and both projections 110b as shown in FIG. 3.

High-frequency current is suitably supplied to the coil 111 from a high-frequency circuit (not shown) and magnetic flux is suitably generated on the core 110. From the shape of the core 110, magnetic flux is concentrated near a fixing nip that is a contacting portion between the heating roller 103 and the pressure roller 104 and magnetic flux and eddy current are generated on the heating roller 103. By this eddy current and resistance of the heating roller 103 itself, so-called Joule heat is generated on the heating roller 103. In other words, only the nip portion, that is the contacting portion between the heating roller 103 and the pressure roller 104, is locally heated.

By way of example, high-frequency current of 20 kHz and 900 W output is suitably supplied to the coil 111 from the high-frequency circuit and the surface temperature of the heating roller 103 is suitably heated to up to about 180° C. The surface temperature is suitably detected by the thermistor 108 and the temperature of the heating roller 103 is suitably controlled through the feedback control.

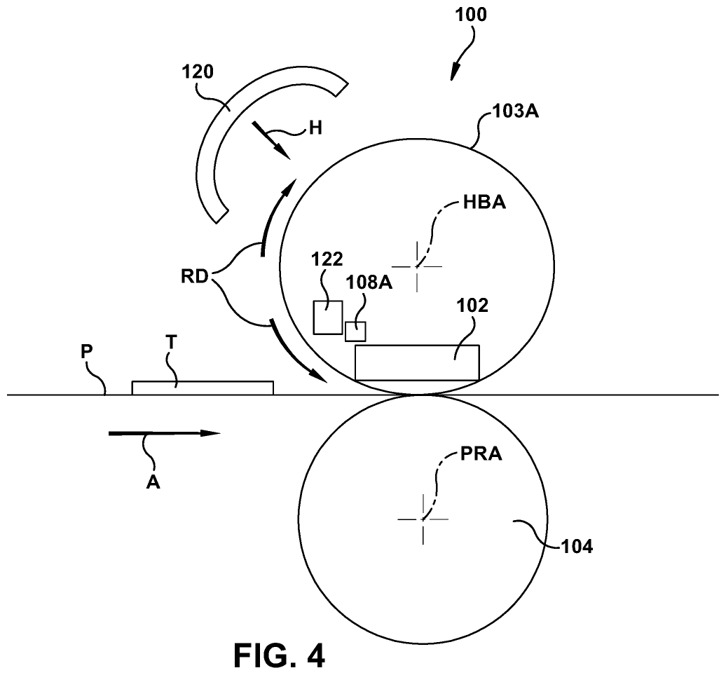

Turning now to FIG. 4, illustrated is a schematic representation of an example belt fuser 100. As indicated, a fixing medium P having toner T from the drum 22 is suitably conveyed in the direction of the arrow A between the heating roller 103, which is suitably a heating belt 103A of a belt fuser, and the pressure roller 104. As indicated in FIG. 4, the heating belt 103A rotates in a counter-clockwise direction about a heating belt axis HBA and the pressure roller 104 rotates in a clockwise direction about a pressure roller axis PRA. An interior heater 102, for example a heater as described above, is suitably disposed interiorly to the heating belt 103A. Additional heat is suitably provided by an exterior heater 120, which is suitably disposed exterior to the heating roller 103, which is suitably a heating belt 103A, as shown. The additional heat from the exterior heater 120 is suitably directed as indicated by the arrow H toward the surface of the heating belt 103A at a radial distance RD from the nip between the heating belt 103A and the pressure roller 104 sufficient to effectively minimize heat loss from the heating belt 103A between the impartation of heat from the exterior heater 120 and the nip. A feedback sensor 122 is suitably disposed interiorly to the heating roller 103 at a location between the application of heat from the exterior heater 120 and the nip between the heating roller 103 and the second roller, which is suitably a pressure roller 104, and suitably provides feedback to the feedback control to regulate heat output between one or both of the interior heater 102 and the exterior heater 120. In an embodiment, an interior thermistor 108A is suitably operatively associated with the feedback sensor 122, ensuring that a sufficient heat is supplied to the toner image.

The interior heater 102 could be induction, conduction or radiation based. The interior heater 102 suitably acts as the primary heat source for the maintaining the temperature of the lubricants and as the energy source to compensate for parasitic losses in the system. The interior heater 102 suitably heats to a temperature of about 150 C to about 180 C. In certain embodiments, this level of heating is suitably insufficient by itself to fuse toner.

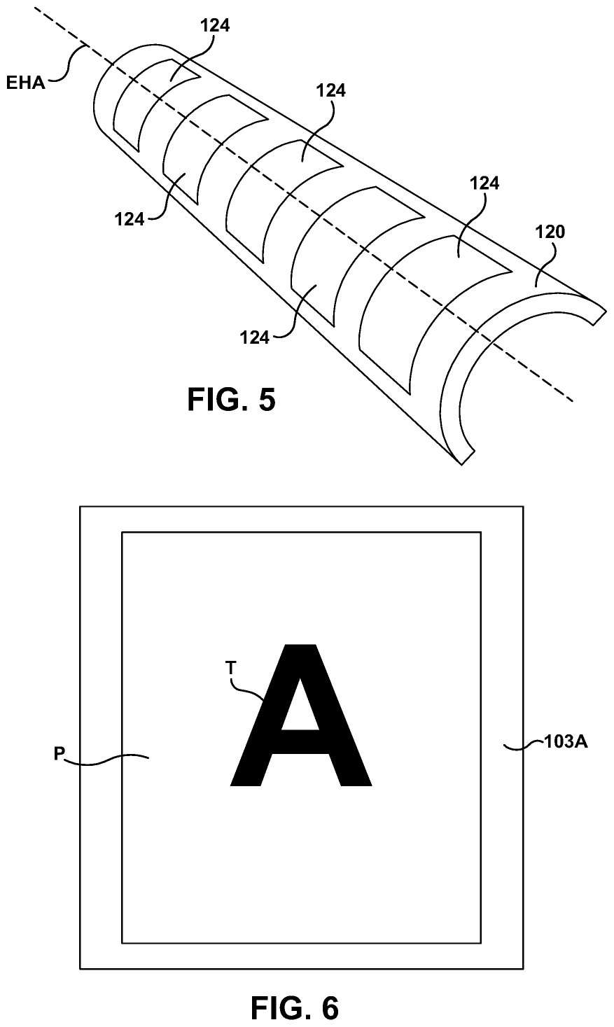

Referring now to FIG. 5, the exterior heater 120 suitably has a generally concave shape in cross-section. Alternatively, the exterior heater 120 suitably has a generally parabolic shape in cross-section, the cross-sectional shape being constant along a longitudinal exterior heater axis EHA, which is suitably generally parallel the heating belt axis HBA of the heating belt 103A. The exterior heater 120 is suitably a multi-segment array and suitably includes a plurality of individually controlled exterior heating elements 124. The plurality of individually controlled exterior heating elements 124 is suitably an axial array aligned along the longitudinal exterior heater axis EHA. The number, type, and placement of exterior heating elements 124 is suitably varied according to the desired intensity and segmentation of heat delivery to, for example, delivering selectively greater heat to sections of the heating belt 103A that has higher stress or higher toner coverage.

The exterior heater array suitably delivers heat by conduction, radiation, or combinations thereof. In an embodiment, the exterior heating elements 124 deliver radiation heat. Since the location of the exterior heater 120 is on the exterior of the heating belt 103A, any energy applied to the heating belt 103A will not need to conduct though the heating belt 103A and the energy will be available immediately to fuse toner particles T. The activation of the individually controlled exterior heating elements 124 is suitably timed to match the specific needs of the fusing load; toner, and media. In an embodiment, the additional energy applied by the exterior heater 120 is directed locally to achieve local, targeted fusing.

The heating belt 103A suitably consists of a steel, nickel or polyimide base with a silicon rubber cover over the base and an outer PFA or PTFE coating. The fusing energy of the exterior heater 120 is suitably applied to the toner T or print media P though the PFA or PTFE coating.

Thus, in an embodiment, the heating belt 103A is suitably described a belt fuser with heating elements disposed on both the interior and exterior of the belt. The interior heater 102 is suitably a single segment heater. The interior heater 102 suitably maintains a base level of energy in the form of heat in the belt for lubrication, energy losses, and other operational requirements, but may not be supply enough heat for good fusing of a print. The exterior heater 120 suitably supplies additional energy in the form of heat selectively as needed to fuse print, that is, the toner T on a print media P, as more fully explained with reference to the schematic depiction of FIG. 6.

Referring now to FIG. 6, a schematic representation of a print media P in the form of a sheet of paper on the heating belt 103A (in a flattened configuration for illustrative purposes). The print media P suitably has toner particles T disposed thereon, for example the letter “A” as shown, and suitably covers a percentage of the print media P, for example, as low as 1% to 3% of the area of a sheet of paper. The interior heater 102 heats the entire surface of the heating belt 103A, which in turns transfers heat to the entire surface of the print media P. In an embodiment, the heat transferred from the interior heater 102 is insufficient to provide desired fusing of the toner particles T. The exterior heater 120 suitably provides heat from one or more of the exterior heating elements 124, each of which is suitably used to provide heat to the heating belt 103A in locations corresponding to the placement of the toner particles T. In this manner, sufficient heat to effectively fuse toner particles T is suitably provided by the one or more of the exterior heating elements 124.

In an embodiment, the interior heater 102 also suitably comprises segmented heater elements to selectively heat portions of the heating roller 103. In an embodiment either the interior heater 102 or the exterior heater 120 suitably heats via conduction, convection or radiation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A belt fuser for allowing a fixing medium on which a toner is transferred as a toner image to pass through a conveyance path and fixing the toner image on a fixing medium, the belt fuser comprising:
a first roller arranged on a surface side of the fixing medium conveyed in the conveyance path and a second roller being arranged opposite to the first roller to sandwich and mutually pressurize the fixing medium;
an interior heater disposed interiorly to the first roller, the interior heater providing a first heat source to an exterior surface of the first roller;
an exterior heater disposed exteriorly to the first roller, wherein the exterior heater provides a second heat source to selectively heat select portions of the exterior surface of the first roller; and
a feedback sensor disposed interiorly to first roller at a location between the application of heat from the exterior heater and a nip between the first roller and the second roller to control heat provided at the nip by the interior heater and the exterior heater.

2. A belt fuser according to claim 1, wherein the interior heater conductively heats the exterior surface of the first roller.

3. A belt fuser according to claim 1, wherein the exterior heater radiates heat to the exterior surface of the first roller.

4. A belt fuser according to claim 1, wherein the exterior heater comprises a concave-shaped cross-section.

5. A belt fuser according to claim 1, wherein the exterior heater is generally concave.

6. A belt fuser according to claim 1, wherein the select portions of the exterior surface of the first roller correspond to the toner image on the fixing medium.

7. A belt fuser according to claim 1, further comprising a feedback sensor interiorly disposed in the first roller.

8. (canceled)

9. A document processing device comprising a belt fuser for allowing a fixing medium on which a toner is transferred as a toner image to pass through a conveyance path and fixing the toner image on the fixing medium, the belt fuser comprising:
a first roller arranged on the surface side of the fixing medium conveyed in the conveyance path and a second roller being arranged opposite to the first roller to sandwich and mutually pressurize the fixing medium;
an interior heater disposed interiorly to the first roller, the interior heater providing a first heat source to an exterior surface of the first roller;
an exterior heater disposed exteriorly to the first roller, wherein the exterior heater provides a second heat source to selectively heat select portions of the exterior surface of the first roller; and
a feedback sensor disposed interiorly to the first roller configured control heat provided by the interior heater and exterior heater in accordance with a monitored temperature of the first roller.

10. A document processing device according to claim 9, wherein the document processing device is a printer.

11. A document processing device according to claim 9, wherein the fixing medium is a sheet of paper.

12. A document processing device according to claim 9, wherein the interior heater conductively heats the exterior surface of the first roller.

13. A document processing device according to claim 9, wherein the exterior heater radiates heat to the exterior surface of the first roller.

14. A document processing device according to claim 9, wherein the exterior heater comprises a concave-shaped cross-section.

15. A document processing device according to claim 9, wherein the select portions of the exterior surface of the first roller correspond to the toner image on the fixing medium.

16. An image forming apparatus, the image forming apparatus comprising:
an image former for forming a toner image on an image carrier;
a transfer device for transferring the toner image formed by the image forming means on a surface of a fixing medium;
a conveyance path in which the fixing medium on which the toner image is transferred by the transfer device is conveyed; and
a belt fuser for fixing the toner image on the fixing medium conveyed in the conveyance path, the belt fuser comprising,
a first roller arranged on the surface side of the fixing medium conveyed in the conveyance path and a second roller being arranged opposite to the first roller to sandwich and mutually pressurize the fixing medium,
an interior heater disposed interiorly to the first roller, the interior heater providing a first heat source to an exterior surface of the first roller,
an exterior heater disposed exteriorly to the first roller, the exterior heater providing a second heat source to select portions of the exterior surface of the first roller, and
a feedback sensor disposed interiorly to the first roller configured to control heat provided by the interior heater and the exterior heater in accordance with a monitored temperature of the first roller.

17. An image forming apparatus according to claim 16, wherein the interior heater conductively heats the exterior surface of the first roller.

18. An image forming apparatus according to claim 16, wherein the exterior heater radiates heat to the exterior surface of the first roller.

19. An image forming apparatus according to claim 16, wherein the select portions of the exterior surface of the first roller correspond to the toner image on the fixing medium.

20. An image forming apparatus according to claim 16 further comprising a feedback sensor interiorly disposed in the first roller.

21. The belt fuser according to claim 1 wherein the feedback sensor includes a thermistor.
